(19) United States
(12) Patent Application Publication
(10) Pub. No.: US 2011/0145336 A1
(43) Pub. Date: Jun. 16, 2011

(54) ELECTRONIC MAIL SERVER AND METHOD FOR AUTOMATICALLY GENERATING ADDRESS LISTS

(76) Inventor: Martin D. Carroll, Watchung, NJ (US)

(21) Appl. No.: 12/636,971

(22) Filed: Dec. 14, 2009

(51) Int. Cl. G06F 15/16

(52) U.S. Cl. 709/206

(57) ABSTRACT

An exemplary method of communicating includes receiving an electronic mail communication at a message server. The communication has an embedded script that indicates at least one characteristic of at least one intended recipient of the communication. A determination is made whether the embedded script corresponds to an identifier of at least one potential candidate recipient from at least one database provided by at least one facilitator that is independent of the message server. At least an indication of the identifier is forwarded to the database facilitator(s). An indication of identified candidate recipients corresponding to the identifier is received from the facilitator(s). An address list is automatically developed based on the identified recipients.

### 1. TECHNICAL FIELD

This invention generally relates to communication. More particularly, this invention relates to addressing communications.

### 2. DESCRIPTION OF THE RELATED ART

A variety of communication techniques are known and in widespread use. Electronic communication such as electronic mail (email) allows individuals to send a variety of type of messages. When a message is intended for one or only a few recipients and the sender has the corresponding address information readily available, manually addressing the message is a straightforward task. When a sender desires to send an email to a set of recipients of a relatively large number or to others with unknown addresses, however, the task of addressing such messages is more difficult and in many cases not possible.

### SUMMARY

An exemplary method of communicating includes receiving an electronic mail communication at a message server. The communication has an embedded script that indicates at least one characteristic of at least one intended recipient of the communication. A determination is made whether the embedded script corresponds to an identifier of at least one potential candidate recipient from at least one database provided by at least one facilitator that is independent of the message server. At least an indication of the identifier is forwarded to the database facilitator(s). An indication of identified candidate recipients corresponding to the identifier is received from the facilitator(s). An address list is automatically developed based on the identified recipients.

An exemplary message server device includes a receiver configured to receive an electronic mail communication having an embedded script that indicates at least one characteristic of at least one intended recipient of the communication. A recipient determining module determines whether the embedded script corresponds to an identifier of at least one potential candidate recipient from at least one database provided by at least one facilitator that is independent of the message server. A communication module forwards at least an indication of the identifier to the database facilitator(s). The communication module receives an indication of identified candidate recipients corresponding to the identifier back from the facilitator(s). The message server automatically develops an address list based on the identified recipients.

The various features and advantages of a disclosed example will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example communication arrangement designed according to an embodiment of this invention.

FIG. 2 is a flowchart diagram summarizing an example approach.

### DETAILED DESCRIPTION

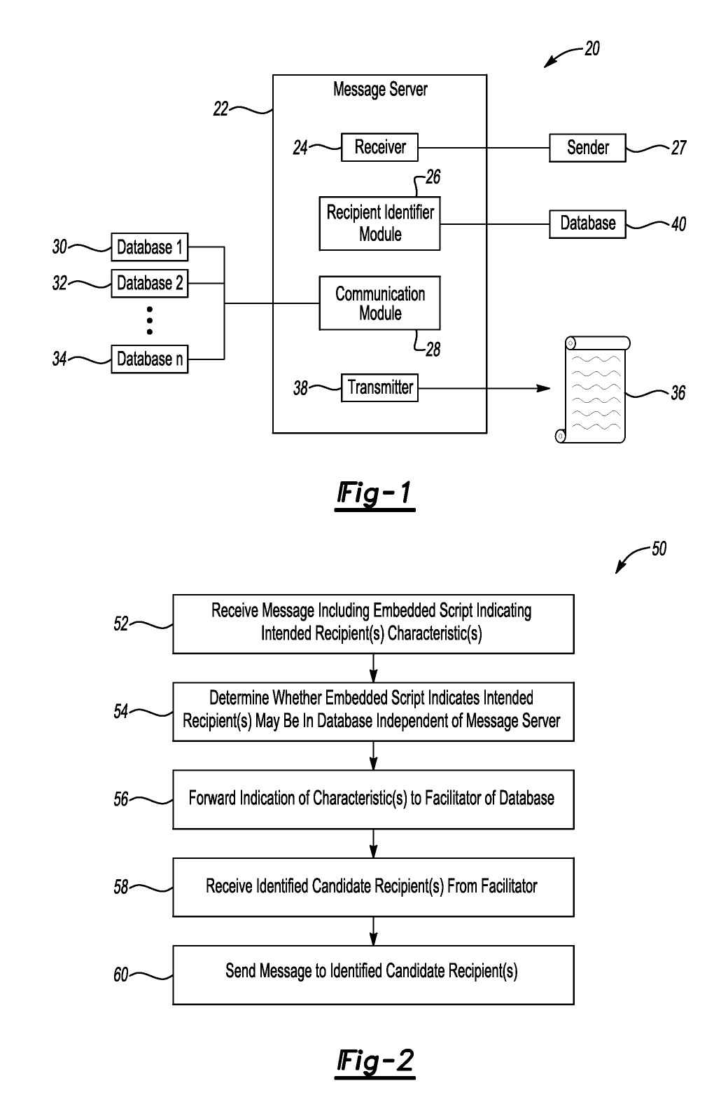

FIG. 1 schematically shows selected portions of a communication arrangement 20 that facilitates sending electronic messages such as email communications. A message server device 22 automatically develops an address list in a manner that accommodates a variety of situations in which manually addressing the message would be difficult, cumbersome or impossible. A receiver portion 24 is configured to receive an electronic communication message from a sender 27. A variety of known communication techniques can be used for communicating messages from the sender 27 to the receiver portion 24.

The message server device 22 includes a recipient identifier module 26 that is configured to automatically develop an address list of recipients to which the message will be sent. The message from the sender 27 includes embedded script that indicates at least one characteristic of at least one intended recipient of the communication. The recipient identifier module 26 is configured to interpret embedded script for purposes of facilitating identification of recipients having the characteristic. In one example, the recipient identifier module 26 comprises a daemon program that knows how to evaluate script language. In one example, the embedded script can be entered by the sender 27 using the sender's native language and the recipient identifier module 26 is capable of interpreting that and converting it into machine-understandable script language. Known machine-based language interpretation techniques are used for this purpose in one example.

One feature of the illustrated example is that the recipient identifier module 26 is capable of making a determination whether the characteristic from the embedded script corresponds to an identifier of at least one potential candidate receipt that would be listed within at least one database that is provided by at least one facilitator that is independent of the message server 22. The illustrated example includes a communication module 28 that is capable of communicating with a plurality of facilitators of a variety of databases 30, 32 and 34 that contain information regarding people based upon different characteristics, relationships, etc. For example, the facilitator of the database 30 in one example is the Facebook utility available over the internet, the facilitator of the database 32 is the operator of the Ancestry.com website and the facilitator of the database 34 is a public institution that includes demographic information regarding individuals.

The communication module 28 forwards at least an indication of the characteristic from the embedded script to appropriate facilitators to gather information from corresponding databases regarding potential candidate recipients of the message. In one example, the recipient identifier module 26 is configured to make determinations regarding what facilitators or what databases are likely to have information corresponding to a particular characteristic so that a list of candidate recipients may be developed. This is done by interpreting the embedded script and recognizing the characteristic(s) of the intended recipients. The communication module 28 receives information from the appropriate facilitator or facilitators or the corresponding database(s) that include the address information for the potential candidate recipients. The recipient identifier module 26, the communication module 28 or both automatically develop an address list 36 to which the message is sent by a transmitter portion 38 of the message server 22.

In one example, the facilitator also provides *scripts* to the message server 22. In such an example, the message server 22 recursively evaluates such scripts and incorporates their results into the final address list. In some examples the message server 22 that first receives a communication containing a script (i.e., an email containing a script or scripts received from facilitators) does not have to fully evaluate the script. Some message servers in some examples are configured to only partially evaluate a script and then send the message on to another message server for further evaluation. For example, some other message servers may have a different local database, be connected with a different set of facilitators or be better configured for interpreting the scripting language.

In the example of FIG. 1, the recipient identifier module has an associated database 40 of candidate recipients. When the embedded script includes indicators or characteristics of intended recipients that the recipient identifier module 26 recognizes as fitting within a search that can be done in the database 40, the recipient identifier module 26 performs such a search. This may be done in addition to or in place of a request made by the communication module 28 to the various facilitators of external databases. In other words, the message server 22 of this example has the ability to automatically develop an address list based upon a dedicated or internal database that is facilitated by the operator of the message server 22. It is possible to merge such an address list with one that is developed based upon information received from databases 30, 32, 34 that are independent of the message server 22 to address the needs of a particular situation.

The division of the message server 22 into various portions is schematically shown for discussion purposes. Those skilled in the art who have the benefit of this description will be able to realize an appropriate server configuration to meet their particular needs.

FIG. 2 includes a flowchart diagram 50 that summarizes one example approach. At 52, a message is received at the receiver portion 24 from the sender 27. The message includes embedded script that indicates at least one characteristic of intended recipients. As one example, an embedded script may indicate that the message is intended for all individuals who graduated from a selected school during a particular year, all individuals who work in a particular department of a selected company, all relatives of a particular individual or all individuals who lived within a specific geographic area during a particular time. In one example, the sender of the message can enter a query or specifier of such information using language that is typically used by that sender. The recipient identifier module 26 in such an example is configured to interpret the embedded script to develop an appropriate machine-recognizable indication of the characteristics of the intended recipients.

In one example, a scripting language is developed for use by the message server 22 having particular functions and operators that allow for expected types of characterizations of recipient groups. Table 1 below shows one example set of functions and operators that is useful in one example.

TABLE 1

| function | semantics |
|---|---|
| anc(X) | all ancestors of each person in X |
| children(X) | all children of each person in X |
| desc(X) | all descendants of each person in X |
| par(X) | parent of each person in X |
| ranc(X) | reflexive version of anc |
| rdesc(X) | reflexive version of desc |
| rsib(X) | reflexive version of sib |
| sib(X) | all siblings of each person in X |
| + | set union |
| * | set intersection |
| − | set subtraction |
| ^{~}, !^{~} | regular expression match, nonmatch |
| =, != | equality, inequality |
| (X) | grouping |

One feature of an example implementation of this invention is that the scripting language capabilities are open-ended so that a variety of different types of characterizations or groupings of intended recipients are possible.

At 54, the recipient identifier module 26 determines whether the embedded script (translated if necessary) indicates that intended recipients may be in a database that is independent of the message server 22. If so, an indication of at least one characteristic is forwarded to a facilitator of an appropriate database at 56.

One example includes establishing relationships between a service provider that manages that message server 22 and the facilitators of the databases that will be accessed for purposes of gathering address information. For example, the message server 22 would be able to gather information from a database managed by Ancestory.com in order to develop an address list based upon an embedded script that indicates that the message should be sent to all descendents of John Doe. The facilitator of such a database uses known techniques for identifying individuals that fit the criteria or characteristics based on the information provided to the facilitator from the communication module 28. In one example, the facilitator returns potential candidate address information to the communication module 28 so that an appropriate address list can be developed by the message server 22. This is shown at 58 in FIG. 2.

One example includes confirming with the email sender that a message should be sent to an automatically developed address list. For example, to protect against appearing as a spammer, one example message server 22 detects when an address list includes more than a threshold number of candidate recipients. If so, a corresponding message or indication is provided to the sender that the number of potential recipients is too large and requests some action by the sender such as refining the embedded script criteria or to make a selection of only a maximum possible number of the candidate recipients. In one example, the sender 27 does not receive the actual address information but only receives an indication of the recipients so that any privacy provided by the facilitators of the databases is maintained (e.g., for the subscribers to those databases).

One example feature of the disclosed example is that it allows for the sender 27 to determine the maximum number of recipients that will be included in the automatically developed address list.

In another example, the message server 22 determines whether at least a minimum number of potential candidate recipients have been identified. If no candidates match the embedded script characteristics, for example, the message server 22 provides an indication to the sender 27 regarding that along with an indication that the message cannot be sent.

Once appropriate confirmation (if necessary) has been received from the sender 27, the message is sent to the identified candidate recipients at 60.

One feature of the disclosed example is that it is not limited to a pre-stored database associated with the message server 22. Not only is it possible to gather information from external databases facilitated independent of the message server 22, but it is possible to obtain a different address list based on the same embedded script used with messages sent at different times. If each of the external databases that are searched based upon a particular embedded script were to change between the sending of one message and a subsequent message using the same embedded script, the address list would change correspondingly. This allows for effortless updating of address lists for purposes of sending messages to as many candidate recipients as possible with as little effort from the sender 27 as possible.

In practice, different facilitators of different databases will provide different mechanisms for users to access their information. In one example, a protocol used by the message server 22 for retrieving information from independent databases is facilitator-dependent. For example, one of the facilitators may utilize query language in which case the message server 22 issues queries from the communication module 28. If a facilitator only provides a web-based interface, the communication module 28 is configured to issue HTTP commands and “scrape” the returned web pages for the information corresponding to identifiers of potential candidate recipients. The recipient identifier module 26 and communication module 28 in the disclosed example are responsible for evaluating the embedded script and using appropriate sources of information and techniques for automatically developing the address list.

The preceding description is exemplary rather than limiting in nature. Variations and modifications to the disclosed examples may become apparent to those skilled in the art that do not necessarily depart from the scope of legal protection given to this invention, which can only be determined by studying the following claims.

I claim:

1. A method of communicating, comprising the steps of:
receiving an electronic mail communication at a message server, the communication having an embedded script that indicates at least one characteristic of at least one intended recipient of the communication;
determining whether the embedded script corresponds to an identifier of at least one potential candidate recipient from a database provided by a facilitator independent of the message server;
forwarding at least an indication of the identifier to the facilitator of the database;
receiving an indication of any identified candidate recipient corresponding to the identifier from the facilitator; and
automatically developing an address list including any identified candidate recipient corresponding to the identifier.

2. The method of claim 1, comprising
interpreting the embedded script to determine a possible meaning of terms in the embedded script; and
determining the identifier from the determined possible meaning.

3. The method of claim 2, comprising
determining whether at least one facilitator provides a database potentially having information corresponding to the identifier; and
forwarding the indication of the identifier to any facilitator of a database determined to include information potentially corresponding to the identifier.

4. The method of claim 3, comprising
forwarding the indication of the identifier to a plurality of facilitators; and
receiving an indication of any identified candidate recipients from each of the plurality of facilitators.

5. The method of claim 1, comprising
providing a listing of identified candidate recipients to a sender of the communication; and
receiving a confirmation from the sender indicating which recipients of the listing should be included in the address list prior to sending the communication to any candidate recipient.

6. The method of claim 5, wherein the confirmation includes an indication of at least one of the candidate recipients to whom the communication should be sent.

7. The method of claim 5, wherein the confirmation includes an indication of at least one of the candidate recipients to whom the communication should not be sent.

8. The method of claim 1, comprising
determining a number of the candidate recipients;
providing an indication to a sender of the communication if the determined number exceeds a threshold; and
providing an indication to the sender of the communication if the determined number is below a predetermined minimum.

9. The method of claim 1, comprising
establishing a relationship between the message server and a plurality of facilitators of databases, the relationship including the facilitators receiving requests from the message server for identification of candidate recipients corresponding to the indication of the identifier in a format recognized by the facilitator.

10. The method of claim 1, wherein the message server is associated with a database and the method comprises
determining whether the embedded script corresponds to a predetermined identifier of at least one known candidate recipient from the database associated with the message server; and
including any known candidate recipient corresponding to the predetermined identifier from the associated database in the automatically developed address list.

11. An electronic mail message server, comprising:
a receiver configured to receive an electronic mail communication, the communication having an embedded script that indicates at least one characteristic of at least one intended recipient of the communication;
a recipient determining module configured to determine whether the embedded script corresponds to an identifier of at least one potential candidate recipient from a database provided by a facilitator independent of the message server;
a communication module configured to
forward at least an indication of the identifier to the facilitator of the database,
receive an indication of any identified candidate recipient corresponding to the identifier from the facilitator; and
wherein at least one of the recipient identifier module or the communication module is configured to automatically develop an address list including any identified candidate recipients.

12. The message server of claim 11, wherein the recipient determining module is configured to
interpret the embedded script to determine a possible meaning of any terms in the embedded script; and
determine the identifier from the determined possible meaning.

13. The message server of claim 12, wherein the recipient determining module is configured to determine whether at least one facilitator provides a database potentially having information corresponding to the identifier.

14. The message server of claim 11, wherein the communication module is configured to
forward the indication of the identifier to a plurality of facilitators; and
receive an indication of any identified candidate recipient from each of the plurality of facilitators.

15. The message server of claim 11, wherein the recipient determining module is configured to
provide a listing of identified candidate recipients to a sender of the communication; and
receive a confirmation from the sender indicating which recipients of the listing should be included in the address list prior to sending the communication to any candidate recipient.

16. The message server of claim 15, wherein the confirmation includes an indication of at least one of the candidate recipients to whom the communication should be sent.

17. The message server of claim 15, wherein the confirmation includes an indication of at least one of the candidate recipients to whom the communication should not be sent.

18. The message server of claim 11, wherein recipient identifier module is configured to
determine a number of the candidate recipients;
provide an indication to a sender of the communication if the determined number exceeds a threshold; and
provide an indication to the sender of the communication if the determined number is below a predetermined minimum.

19. The message server of claim 11, comprising a communication link between the message server and each of a plurality of facilitators of databases, the message server and the plurality of facilitators having relationships including the facilitators receiving requests from the message server for identification of candidate recipients corresponding to the indication of the identifier in a format recognized by the corresponding facilitator.

20. The message server of claim 11, comprising a database associated with the recipient identifier module and wherein the recipient identifier module is configured to determine whether the embedded script corresponds to a predetermined identifier of at least one known candidate recipient from the database associated with the server.
